(19) United States
(12) Patent Application Publication
(10) Pub. No.: US 2026/0269671 A1
(43) Pub. Date: Sep. 10, 2026

(54) Enameled Round Wire and, Methods for Producing Same

(71) Applicant: Innomotics GmbH, Nürnberg (DE)

(72) Inventors: Tobias Katzenberger, Bad Königshofen STT Untereßfeld (DE); Bastian Plochmann, Neustadt an der Aisch (DE)

(73) Assignee: Innomotics GmbH, Nürnberg (DE)

(21) Appl. No.: 18/993,370

(22) PCT Filed: Jul. 3, 2023
(86) PCT No.: PCT/EP2023/068150

§ 371 Date: Jan. 10, 2025

(30) Foreign Application Priority Data
Jul. 13, 2022 (EP) 22184696.7

(51) Int. Cl. H02K 3/32; H01B 3/30; H01B 7/02; H01B 7/42; H01B 19/04

(52) U.S. Cl. CPC H02K 3/32; H01B 3/306; H01B 3/308; H01B 7/0225; H01B 7/42; H01B 19/04

(57) ABSTRACT

Some examples of the teachings herein include enamel-insulated wires. An example system includes: a round electrical conductor; and a wire enamel surrounding the electrical conductor. A layer of thermally unstable material includes at least one of: a lubricity constituent as topmost layer and/or a thermally unstable layer as a penultimate layer of the wire enamel directly bordering the surface.

### CROSS-REFERENCE TO RELATED APPLICATIONS

This application is a U.S. National Stage Application of International Application No. PCT/EP2023/068150 filed Jul. 3, 2023, which designates the United States of America, and claims priority to EP Application No. 22184696.7 filed Jul. 13, 2022, the contents of which are hereby incorporated by reference in their entirety.

### TECHNICAL FIELD

The present disclosure concerns wires. Various embodiments of the teachings herein include enamel-insulated round wires and methods for producing an enamel-insulated round wires.

### BACKGROUND

One widespread example of an enamel-insulated round wire is a copper wire, thus what is called an enameled copper wire. An enameled copper wire is an insulated conductor which during manufacture has been coated with an electrically insulating enamel layer. The thickness and weight of this enamel insulation is very low by comparison with other insulating materials of equal effect. An enameled copper wire may therefore be used for constructing electrical coils, transformers and machines. Further applications include solderable jumper wires and also the production of litz wires.

The use of enameled copper wire reduces the mechanical size of electrical machines, providing space-saving effects through the concentration of the electrical and magnetic fields on a smaller space as part of the winding technique. Ultimately, this reduction in size makes for shorter conduction paths and so also leads to energy savings for a given power output.

Electrical insulation enamels are employed in the coating of enameled copper wires which are used as electrical conductors in electrical components such as coils, rotors and stators. To produce these electrical components, the coated and insulated round wire is wound using automated winding machines. In this process, the enameled electrical wires should not be damaged at the edges of the electrical components and should go easily into the slots in the components, enabling a high packing density of the wire in the electrical components. High packing densities are needed to achieve optimal induction performance. A high packing density is also desirable as electrical machines such as electric motors containing such electrical components, for example, are becoming more and more miniaturized, owing to a heightened demand for ever smaller devices and components.

Low-voltage motors are typically produced using wound round enameled wires, which are drawn into the laminated stator core after the winding operation. A limiting factor here is the copper filling in the slot, in other words the number of wires which can be introduced into the slot in a fully automated procedure by means of this technology. The enameled copper wires are first wound around a template, using what is called a flyer winder, and are subsequently drawn as a bundle into the slot. In this operation, the initially highly ordered winding undergoes no further fixing, meaning that unfavorable layering may occur, including wire crossing, for example. Such crossing additionally increases the effective cross section of the wire bundles, thereby further increasing the required drawing force and hence the load both on the drawing equipment and on the winding. To minimize these forces and hence increase the maximum possible copper filling, the prior art employs a coating of lubricious waxes, e. g., paraffins. A marked increase in the lubricity is also generated through the utilization of siloxane copolymers in the topmost wire enamel layer.

An effective lubricity therefore allows the enameled copper wire to be processed in modern high-speed winding equipment, in which the enameled copper wire is greatly stressed by wire, braking and/or guiding systems. For these reasons, the feature of the lubricity of wires has developed to become an important quality feature for the production and processing of insulated round wires.

EP 3769403 A1 describes an electric motor with an electrical insulation system EIS which comprises electrical conductors in the form of round enameled wires with a round enameled wire winding arranged in a slot in a laminated core of a stator. The spaces between the conductor windings are filled with impregnating resin. The amount of impregnating resin is determined by introducing a carrier containing impregnating resin into the conductor to provide sufficient potting of the spaces in the conductor of the laminated core. Here, the impregnating resin wets the surface of the round wire enamel prior to curing.

The wire enamel itself comprises a multiplicity of individual polymeric layers, made for example of polyethylene “PE”, polyetherimide “PEI”, polyamideimide “PAI” and/or polyimide “PI”, with for example each layer itself being applied lubriciously on the layer below it and/or above it, so as to be flexible in respect of mechanical loading, e.g., stretching, bending, etc.

The siloxane copolymer technology makes it possible—at least in the topmost wire enamel layer—to realize very high levels of copper filling with full automation, although retrospective impregnation—of the filled slot, for example—by means of impregnating resin comprising polyetherimide, polyether and/or epoxy resin, for example, is not possible, owing to repulsion between the impregnating resin and the chemical surface groups which produce the lubricity. It is impossible to produce any chemical attachment between the nonpolar functional groups, siloxane groups or fluoro groups for example, i.e., between the antifriction varnish surface on the one hand and the polar impregnating resin on the other. Impregnating a round wire of high lubricity, produced by fluoro and/or siloxane groups at the surface, has therefore been impossible to date. For low-voltage motors, however, impregnating resins are generally employed in the slots.

### SUMMARY

Teachings of the present disclosure include round wire enamels that combine high lubricity with good capacity for impregnation using the conventional impregnating resins based on polyurethane, polyetherimide, polyether and/or epoxy resin. For example, some embodiments of the present disclosure include an enamel-insulated round wire comprising an electrical conductor insulated with wire enamel that surrounds the round wire in the manner of a jacket, such that a layer of thermally unstable material is provided as topmost layer or as a penultimate layer of the wire enamel insulation, directly bordering the surface.

As another example, some embodiments include a method for producing an enamel-insulated round wire, comprising: applying polymerizable enamel material in layers to the round wire, curing and polymerizing the enamel material in layers to give a thin polymerized enamel layer, optionally repeating the first two method steps until a round wire with enamel insulation in a multilaminar wire enamel system is present, applying a thermally unstable layer over said system, producing the winding, drawing the winding into the slot, heating the filled slot, to initiate decomposition of the thermally unstable layer, impregnating by immersing in liquid impregnating resin, and subsequently curing.

Another example includes the use of an enamel-insulated round wire as described herein and a lamina thereon of thermally unstable material for producing low-voltage electric motors.

### BRIEF DESCRIPTION OF THE DRAWINGS

The teachings of the present disclosure are elucidated in more detail below using three figures, which show the prior art and illustrative embodiments of the teachings herein. In the drawings:

FIG. 1 shows an overview of the prior art for the typical construction of enamel-insulated round wires and their presence as an impregnated assembly in a slot, of a low-voltage electric motor;

FIG. 2 shows an example system incorporating teachings of the present disclosure; and

FIG. 3 shows another example system incorporating teachings of the present disclosure.

### DETAILED DESCRIPTION

In some embodiments, an antifriction varnish layer is applied over the thermally unstable layer and, on decomposition of the thermally unstable layer, becomes at least perforate and/or is wholly or partially removed at certain points owing to release of gas from the decomposing lower thermally unstable layer. The antifriction varnish layer may be provided over the full area or partially; in the case of partial coating with antifriction varnish, the latter floats regionally like ice floes on the lower layer, especially in the case of melting on the lower layer. The antifriction varnish may account for a fractional area in the range, for example, of 40% to 100%, 50% to 99%, or from 55% to 95% of the surface area of the wire enamel insulation.

In some embodiments, an antifriction varnish is designed chemically such that the base is thermally unstable, with lubricity being achieved superficially by introducing, copolymerizing, mixing and/or blending the base polymer with lubricity constituents. Examples of such lubricity constituents are paraffins, waxes, soaps, lubricants, lubricant solids, organic groups and compounds such as surfactants, organosilicon compounds, thus especially siloxanes, polysiloxanes, silazanes, polysilazanes, boron nitride, fluorinated compounds such as perfluorooctanoic acid “PFOA”, polytetrafluoroethylene “PTFE” or “Teflon®”, and the like in the thermally unstable wire enamel insulating layers.

In some embodiments, the topmost wire enamel insulating layer is made of a thermally unstable material such as polyethylene, so that following introduction into the slot, when this layer is heated, it decomposes and exposes the underlying layers, which are part of a multilaminar wire enamel system, for example, which is compatible with the impregnating resins. The thermally unstable layer comprises, for example, a compound selected from the group encompassing the following: polyethylene, polyethylene glycol, polyolefin and/or polyolefin wax alone or in any desired combinations. By varying the chain length of the polymer here it is possible to influence the temperature stability. In principle, the temperature stability is shifted to higher temperatures with a longer chain length.

The impregnation of electric motors frequently entails using the process referred to as the electrical UV process, where the stators are heated beforehand—before being immersed into the liquid impregnating resin—by electrical energization of the individual phases. In this case, the temperatures in the copper windings, which are heated directly through the Joule effect, indeed, briefly reach 200° C. to 300° C., before the heat is distributed—relatively —uniformly in the stator. Connecting up the stators and heating them is therefore customary in order also to reduce the viscosity of the impregnating resin and to induce controlled chemical gelling.

Conventional wire enamels comprise two or more—in the range from 3 to 30, for example—layers of different or like polymers, e. g., polyetherimide, polyetherimine and/or polyamideimide, and also any desired combinations or mixtures thereof. The general term for this is a multilaminar wire enamel system for the wire-insulating enamel. Employed in particular for the multilaminar wire enamel system are impregnating resins based on polyurethane, saturated and, with particular preference, unsaturated polyesterimide, polyamideimide, polyester and/or epoxy resin, and also any desired combinations, mixtures, copolymers and/or blends thereof.

The number of layers varies, being situated for example between 3 and 25 layers, 7 to 20 layers, 10 to 20 layers, or at 15 layers. The layers may be cured separately from one another, so that lubricious interfaces are formed between each of them and no chemical bonding occurs between the layers. For example, the thermally unstable layer may also be applied as a topmost layer which is somewhat thicker by comparison with the other wire enamel layers.

The layers of the multilaminar wire enamel system for the wire enamel insulation of round wires are situated in terms of the layer thickness in the range from 0.2 μm to 200 μm, from 0.3 μm to 50 μm or between 0.5 to 20 μm.

The thermally unstable layer is also applied, for example, as a prepreg based on polyethylene and/or polyethylene glycol.

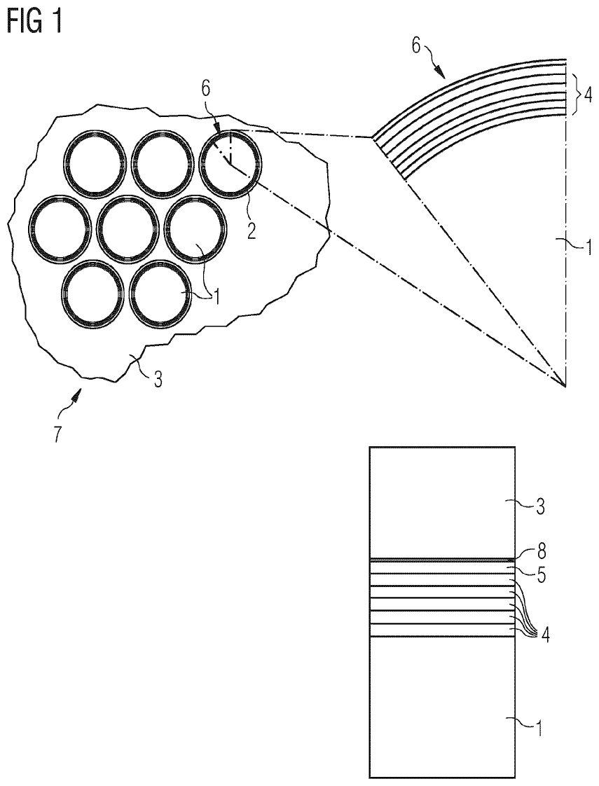

FIG. 1 shows an overview of the prior art for the typical construction of enamel-insulated round wires and their presence as an impregnated assembly in a slot, of a low-voltage electric motor such as a traction motor, for example. An assembly 7 is apparent, comprising round wires 1 enamel-insulated with wire enamel 2 and impregnated with impregnating resin 3.

Shown on the right next to the assembly is an enlarged conical detail 4, with again the round wire 1 and wire enamel 2 being apparent. For the wire enamel 2, the individual layers 4 are apparent in the enlarged representation.

Beneath the detail view is a further enlargement of the conical detail shown above, here showing a further prior art. In this case, above the usual wire enamel layers 2 with a layer system 4, for example, as shown above, there is a layer 5 of antifriction varnish. This antifriction varnish layer 5 comprises, for example, a siloxane copolymer, so giving the antifriction varnish layer 5 a lubricious surface 8, from which the impregnating resin 3, however, unfortunately runs off in beads.

Directly bordering the region between round wire 1 and conventional wire enamel 2, accordingly, is this laminar of antifriction varnish 5 with lubricity additive—for example, with a siloxane copolymer —and following this a dashed interface 8, shown in red, on the surface of the antifriction varnish layer 5, which illustrates the at least poor or even entirely absent chemical attachment of the impregnating agent 3 to the topmost antifriction varnish layer 5, enriched with lubricating agent at the surface, in FIG. 1. On account of this layer 8, which would form according to the prior art if the round wires were impregnated with antifriction varnish layer 5 containing impregnating resin 3, the problem of the present invention arises. The technique with antifriction-enameled wires is employed in principle only without subsequent impregnation, since impregnation has nothing to offer technically when the impregnating resin 3 runs off in beads from the antifriction varnish 5.

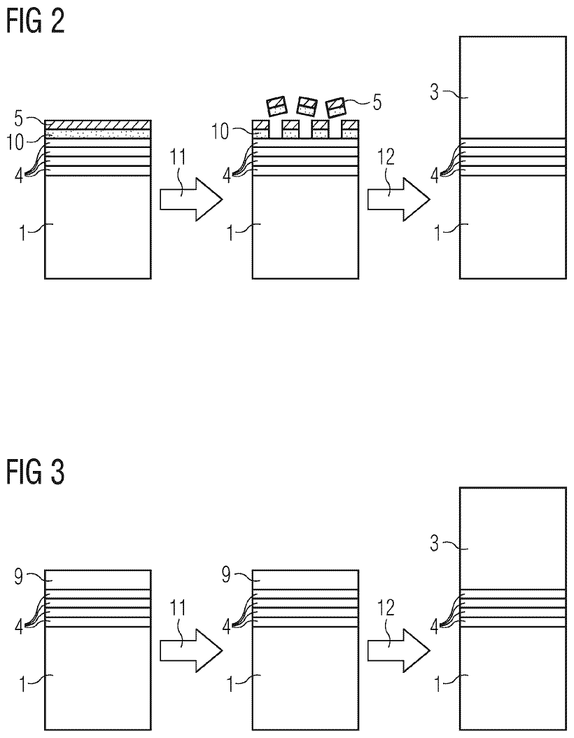

FIG. 2 shows an example system incorporating teachings of the present disclosure. Utilized again is the multilaminar wire enamel system 2 or 4, respectively, on the round wire 1. As the topmost, “last” layer, a thin layer 5 of antifriction varnish is applied. There are numerous antifriction varnishes 5 which are suitable for the field of use that is relevant here. Suitability is possessed, for example, by natural waxes, montan waxes, polyethylene waxes, and copolymers with propylene polymers from higher α-olefins, polypropylene oxides, esters of higher functional polyols, and relatively long-chain fatty acids. Also suitable as the antifriction varnish for the antifriction varnish layer 5, however, are polytetrafluoroethylene dispersions, as known from WO 2007/045575. Lastly, there are antifriction varnish layers 5 with siloxane copolymer which are suitable as antifriction varnish layer 5. In a further approach to improving the lubricity of electrical insulating varnishes, the polymers contained in the varnish are functionalized with components, an example being the modification of polyamideimides with terminal, relatively long-chain alkyl groups.

Located below the last, topmost antifriction varnish layer 5 and directly following it, as a “penultimate” layer, is a thermally unstable layer 10, composed of polyethylene glycol, for example. The thermally unstable layer 10 may also be made of a different suitable polymer which decomposes at relatively high temperatures, of the kind occurring, for example, in the production of low-voltage motors with ready-filled stator slots and which causes at least partial explosive removal—by evolution of gas, for example, such as evolution of C02—as shown according to the arrow 11 in FIG. 2.

The system of FIG. 2 uses the multilaminar construction of a wire enamel in order to utilize the topmost layer of antifriction varnish favorably for the process of drawing the enamel-insulated round wires into the stator slot of the motor and subsequently—after the filling of the slot—to carry out destruction of the antifriction layer through introduction of temperature, by the “bursting” of an underlying layer, to an extent such as to expose a surface which can be attached chemically with the impregnating resin. Apparent on the very left in FIG. 2 is a thermally unstable layer 10, as the “penultimate” thin lamina on the multilaminar wire enamel system 2-4. Located above it is the last layer of antifriction varnish 5, which cannot be attached chemically to the impregnating resin.

Arrow 11: By heating, for example by electrical energization, of the winding already present in the slot, during the production of the motor, temperature is introduced and causes decomposition of the thermally unstable layer 10. The decomposition generally releases C02 in gas form and so brings about bursting of the overlying antifriction varnish layer 5 at numerous points, causing the material of the penultimate layer 10 to come to lie on the surface of the enamel insulation. See the middle representation in FIG. 2.

Arrow 12: Impregnation of the winding with impregnating resin 3 now meets a surface which consists at least partly of thermally unstable layer 10, thereby enabling effective chemical attachment of the impregnating agent 3 to the thermally unstable layer 10 at these points. In addition, below the decomposed thermally unstable layer 10, the multilaminar wire enamel system 2 or 4, respectively, is exposed, and is also able to mediate effective chemical attachment to the impregnating resin 3.

Evident on the left in FIG. 2, then, is the effective-in accordance with the invention-chemical attachment of the impregnating resin 3 to the surface of the enamel-insulated round wire 1, since at many points the material of the thermally unstable layer 10 or of the multilaminar wire enamel 4 forms the surface of the wire insulation.

FIG. 3 shows another example system incorporating teachings of the present disclosure. In this case, through introduction of siloxane groups into the thermally unstable layer, after the drawing of the antifriction varnish-coated round wires into the slot, the subsequent heating is accompanied by at least partial decomposition of the antifriction varnish layer, thereby exposing the underlying multilaminar wire enamel system 4 and enabling effective chemical attachment superficially with an impregnating resin.

Represented in detail is again, on the left, the structure of a round wire 1 drawn into the slot by means of superficial antifriction varnish 9. The design of the antifriction varnish 9 is such that, in addition to the lubricity properties achieved through the presence of siloxane groups, it has a thermally unstable material as its base material, such as polyethylene and/or polyethylene glycol, for example.

Accordingly, the introduction of temperature-represented by arrow 11—that takes place during production of a motor is accompanied by breakdown of the antifriction varnish 9 based on thermally unstable material. Below the antifriction varnish 9, the multilaminar wire enamel system 4 is exposed, and on impregnation with impregnating resin 3—see arrow 12—has a surface which allows for effective attachment chemically to the impregnating resin 3.

It is possible accordingly to utilize the advantages both of the antifriction varnish technology and of impregnation. It has not to date been possible to impregnate lubricious wire enamels, especially including those with siloxane group-containing polymers, because the topmost, “last” antifriction layer has nonpolar properties owing to the siloxane groups in the context of the multilaminar structure of the wire enamel. The invention shows that the multilaminar structure can be utilized to at least break open the topmost antifriction varnish layer, by means of the intermediate step which is often present in any case, with introduction of temperature via electrical energization and/or Joule heating briefly to 200° C. or more, so that subsequent impregnation with liquid impregnating resin is able to attach to the thermally unstable layer located below the topmost antifriction layer.

### LIST OF REFERENCE SIGNS

1 round wire
2 wire enamel
3 impregnating resin
4 multilaminar wire enamel system
5 antifriction varnish according to the prior art
6 detail
7 assembly composed of enamel-insulated round wires and impregnating resin
8 interface which chemically does not attach to impregnating resin
9 thermally unstable antifriction varnish layer
10 thermally unstable penultimate layer
11 arrow

What is claimed is:

1. An enamel-insulated wire comprising:
a round electrical conductor; and
wire enamel surrounding the electrical conductor;
the wire enamel includes a layer of thermally unstable material including at least one of: a lubricity constituent as outermost layer and/or a thermally unstable layer as a penultimate layer of the wire enamel, directly bordering the surface.

2. The enamel-insulated wire as claimed in claim 1, wherein the wire enamel includes a multilaminar wire enamel system having 2 to 40 layers.

3. The enamel-insulated wire as claimed in claim 2, the wire enamel system has 10 to 20 layers.

4. The enamel-insulated wire as claimed in claim 1, wherein individual layers of the wire enamel have a layer thickness in the range from 0.2 to 200 μm.

5. The enamel-insulated wire as claimed in claim 2, wherein individual lamina of the multilaminar wire enamel system comprise polymeric material.

6. The enamel-insulated wire as claimed in claim 4, wherein individual laminas of the multilaminar wire enamel system comprise an impregnating resin selected from the group of compounds consisting of: epoxy, polyetherimide, polyurethane, and polyamideimide.

7. The enamel-insulated wire as claimed in claim 2, wherein each wire enamel layer cured before application of a following layer and so lubricious surfaces are present between the layers.

8. The enamel-insulated wire as claimed in claim 1, wherein the thermally unstable layer comprises one or more lubricity constituents.

9. The enamel-insulated wire as claimed in claim 1, wherein the thermally unstable layer comprises siloxane, silazane, and/or groups giving the thermally unstable layer a lubricious surface.

10. The enamel-insulated wire as claimed in claim 1, the thermally unstable layer comprising a material selected from the group consisting of: polyethylene, polyethylene glycol, polyolefin wax, and polyethylene wax.

11. The enamel-insulated wire as claimed in claim 1, wherein the thermally unstable layer is thicker than all other layers of the multilaminar wire enamel system.

12. The enamel-insulated wire as claimed in claim 2, the multilaminar wire enamel system having a thermally unstable layer as penultimate layer and an antifriction varnish layer surrounding the thermally unstable layer.

13. A method for producing an enamel-insulated round wire, the method comprising:
applying polymerizable enamel material in a first layer to a round conductor;
curing and polymerizing the enamel material in the first layers to produce a thin polymerized enamel layer;
repeating the application and curing of enamel material in layers to produce a round wire with a multilaminar wire enamel system; and
applying a thermally unstable layer over the multilaminar wire enamel system.

14. The method as claimed in claim 15, wherein heating includes electrical energization.

15. A method for producing a winding, the method comprising:
applying polymerizable enamel material in a first layer to a round conductor;
curing and polymerizing the enamel material in the first laver to produce a thin polymerized enamel layer;
repeating the application and curing of enamel material in lavers to produce a round wire with a multilaminar wire enamel system;
applying a thermally unstable layer over the multilaminar wire enamel system;
drawing the conductor into a slot;
heating the slot to initiate decomposition of the thermally unstable layer;
immersing the slot in a liquid impregnating resin; and
curing the winding at temperature.
